(19) United States
(12) Patent Application Publication
(10) Pub. No.: US 2022/0371313 A1
(43) Pub. Date: Nov. 24, 2022

(54) MULTILAYER PULTRUDED STRUCTURE HAVING A CHEMICAL RESISTANT AND WEATHERABLE TOP LAYER

(71) Applicant: ARKEMA FRANCE, Colombes (FR)

(72) Inventors: Jing-Han Wang, Blue Bell, PA (US); Mary Katherine Calvin, Havertown, PA (US)

(73) Assignee: Trinseo Europe GmbH, Horgen (CH)

(21) Appl. No.: 17/771,670

(22) PCT Filed: Oct. 28, 2020
(86) PCT No.: PCT/US2020/057631

§ 371 Date: Apr. 25, 2022

Related U.S. Application Data
(60) Provisional application No. 62/927,150, filed on Oct. 29, 2019.

(51) Int. Cl. B32B 37/15; B32B 7/08; B32B 27/08; B32B 27/12; B32B 27/16; B32B 27/26; B32B 27/30

(52) U.S. Cl. CPC B32B 37/15; B32B 7/08; B32B 27/08; B32B 27/12; B32B 27/16; B32B 27/26; B32B 27/304; B32B 27/308; B32B 2250/03; B32B 2250/24; B32B 2250/44; B32B 2255/10; B32B 2260/046; B32B 2270/00; B32B 2327/12; B32B 2307/714; B32B 2307/732; B32B 2307/712; B32B 2419/00

(57) ABSTRACT

The invention relates to a multilayered pultruded structures having a weatherable cap layer over a pultruded substrate. The cap layer provides improved weatherability, chemical resistance and surface quality for pultruded structures. The cap layer is either an acrylic, vinyl or styrenic cap layer covered with a thin layer blend of polyvinylidene fluoride and acrylic polymers, or a cross-linked acrylic outer layer. A useful cap layer would be a UV resistant acrylic cap layer, such as a Solarkote® resins from Arkema, covered by a co-extruded blend of polyvinylidene fluoride, such as Kynar® resins from Arkema, with an acrylic resin, such as Plexiglas® resins from Arkema. The highly weatherable and chemical resistant pultruded structure is especially useful in window and door profiles.

### CROSS-REFERENCE TO RELATED APPLICATIONS

This application is the U.S. national phase of International Application No. PCT/US2020/057631, filed 28 Oct. 2020, which claims priority to U.S. Provisional Application No. 62/927,150, filed 29 Oct. 2019, the disclosure of each of these applications being incorporated herein by reference in its entirety for all purposes.

### FIELD OF THE INVENTION

The invention relates to a multilayered pultruded structures having a weatherable cap layer over a pultruded substrate. The cap layer provides improved weatherability, chemical resistance and surface quality for pultruded structures. The cap layer is an acrylic, vinyl or styrenic cap layer. The cap layer is covered with a thin layer blend of polyvinylidene fluoride and acrylic polymers, or a cross-linked acrylic outer layer. The highly weatherable and chemical resistant pultruded structure is especially useful in window and door profiles.

### BACKGROUND OF THE INVENTION

Pultruded substrates are used as replacements for wooden profiles in structures exposed to the weather, especially in residential windows and window frames, and doors and doorframes. In pultrusion, a fiber-reinforced substrate is formed by pulling a blend of fibers and a thermoset resin through a die. This fiber/thermoset blend is often called a fiberglass reinforced plastic (FRP). The resulting profile, is then coated with a durable thermoplastic polymer to improve the aesthetics and weathering properties.

With the higher modulus of the polyurethane-based, capped pultrusion structures, they could be used as replacements for coated aluminum and other metallic structural materials in commercial applications. Some of the possible uses would include window profiles, playground equipment, telephone poles and light poles, and seawater barriers. Based on the higher modulus, and high weatherability of a capped polyurethane pultrusion structure, one of skill in the art can imagine other uses for these lighter weight, weatherable replacements for coated metal structures.

U.S. Pat. No. 4,938,823 describes such a process, in which the fiber reinforced plastic (FRP) articles are formed by a pultrusion process, followed by the application of a thermoplastic external layer. The thermosetting resins mentioned are alkyds, diallyl phthalates, epoxies, melamines ureas, phenolics, polyesters and silicones. The thermoplastic, such as an acrylic, styrenic, or polyolefin is applied by a crosshead extrusion process directly onto the pultruded FRP, or optionally may be used with a primer adhesive coating or adhesion promoter.

U.S. Pat. No. 6,197,412 describes the direct crosshead extrusion of a weatherable cap layer, such as an acrylic, or fluoropolymer onto the pultruded substrate without using any adhesive. The pultruded substrate is flame, corona or plasma-treated to create radicals on the surface to improve adhesion. US 2009/0081448 describes the direct extrusion of two different cap layers onto a pultruded substrate, without the use of any adhesive.

Typical commercial pultrusion products are formed from a pultruded fiber-reinforced polyester resin substrate (with some alkyds, diallyl phthalates, epoxies, melamines/ureas, and phenolics resins also used) having an acrylic or styrenic cap directly co-extruded on top.

The problem with these materials is that weatherability, colorfastness and surface appearance could be improved.

Another problem with currently used polyester pultrusion, is that the modulus is not high enough for general use in the commercial building area. Polyurethane is known to have a higher modulus, and especially a higher transverse modulus than polyesters. However, thermoplastic capping materials do not adhere well to polyurethane-based pultrusion structures. Polyurethane resins are not described in the cited prior art.

In US 2017/0036428 applicant has described a tie layer useful in adhering a polar, thermoplastic capstock to a pultruded thermoset resin. The application mentions the use of a fluoropolymer blended into the capstock layer, and also the use of a thin fluoropolymer outer layer. There is no description of any ratio of acrylic to fluoropolymer in any layer, nor the molecular weight of the acrylic resin to be blended with any fluoropolymer.

### PROBLEM

Pultruded polyester and polyurethane structures lack good surface appearance properties, as well as having poor weatherability and chemical resistance. Surface appearance and weatherability are improved by adding a cap layer, generally of an acrylic or styrenic polymer, over the pultruded structure.

While vastly improving the weatherabiity of a pultruded substrate, acrylic, styrenic and vinylic cap layers have insufficient chemical resistance to some chemicals they may be exposed to during manufacture, installation, and use. Chemicals, such as household cleaners, paints, adhesives, that may contain chemicals and solvents such as isopropyl alcohol, methyl ether ketones, etc. can damage the surface of typical cap layers. Further, flame resistance of typical acrylic, styrenic and vinylic cap layers is limited.

Fluoropolymers are known for their chemical resistance, flame resistance, moisture resistance and weatherability. A thin fluoropolymer outer layer can be applied on top of the cap layer, to further increase weatherability and chemical resistance. Unfortunately, there are at least four difficulties with this approach. First, it has been that a pure polyvinylidene fluoride (PVDF) layer results in glossy streaks and an uneven surface. Second, while polyvinylidene fluoride and acrylics are miscible in the melt phase, there is only a small amount of miscibility achieved during a coextrusion of separate PVDF and acrylic layers. Third, pure PVDF is difficult to process. Fourth, pure PVDF is expensive compared to acrylics.

### SOLUTION

It has now been found that a special chemical resistant outer layer can be added to a pultruded structure having a capstock to improve the chemical resistance and water haze resistance of a pultruded structure. A thin outer layer of a fluoropolymer-rich blend with an acrylic provides better processing and increased adhesion, over a pure fluoropolymer layer, while significantly improving chemical resistance and water haze resistance.

An alternative solution to the problem of increased chemical resistance can be provided by a cross-linked outer layer. UV-curable coatings, or acrylic capstock resins formulated with stabilized di-acrylics or multi-functional (meth)acrylic monomers can be activated after the extrusion step by UV or e-beam radiation.

### SUMMARY OF THE INVENTION

In a first aspect, the invention relates to a weatherable, chemical resistant pultruded structure comprising, in order from the inside to the outside:
a) a pultruded structure comprising a fiber-reinforced thermoset or thermoplastic resin;
b) optionally one or more tie layers,
c) one or more thermoplastic cap layers, and
d) a thin, outermost chemical resistant layer.

In a second aspect, the chemical resistant layer is less than 0.5 mm, and preferably less than 0.25 mm in thickness.

In a third aspect, the chemical resistant layer is selected from the group consisting of a fluoropolymer-rich blend of at least one polyvinylidene fluoride homopolymer or copolymer and one or more (meth)acrylic polymers.

In a fourth aspect, the chemical resistant layer comprises a polymer matrix blend of 51 to 95 weight percent of polyvinylidene fluoride (PVDF) and 5 to 49 weight percent of (meth)acrylic resin, preferably 60 to 93 weight percent PVDF with 7 to 40 weight percent (meth)acrylic resin, and most preferably 70 to 90 weight percent PVDF with 10 to 30 weight percent (meth)acrylic resin.

In a fifth aspect, the polyvinylidene fluoride polymer comprises greater than 60 weight percent, and more preferably greater than 75 weight percent of vinylidene fluoride monomer units, and said (meth)acrylic polymers comprise high molecular weight polymers, having a molecular weight of from 50,000 g/mol to 500,000 g/mol, preferably 75,000 g/mol to 250,000 g/mol, more preferably 90,000 g/mol to 150,000 g/mol, and more preferably 105,000 g/mol to 150,000 g/mol.

In a sixth aspect, the chemical resistant layer is a radiation curable acrylic layer.

In a seventh aspect, at least one tie layer is selected from the group consisting of 1) an extrudable thermoplastic tie layer that is coextrudable with at least one of the pultruded structure a) or thermoplastic cap layer c), and 2) a radiation curable coating;

In an eighth aspect, the optional tie layer is selected from the group consisting of polyamides, copolyamides, block copolymers of polyamide and polyester; acrylic, stryrenic or butadiene-based block copolymers, functionalized olefins, functionalized acrylics, polylactic acid (PLA), acrylonitrile-butadiene-styrene (ABS) copolymer, and a radiation-curable adhesive.

In a ninth aspect, the pultruded structure comprises a polymer matrix selected from the group consisting of alkyds, diallyl phthalates, epoxies, melamines, ureas, phenolics, polyesters, polyurethanes, polyesters, a thermoplastic acrylic resin.

In a tenth aspect, the cap layer comprises a thermoplastic selected from the group consisting of acrylics, styrenics and thermoplastic polyurethane.

In an eleventh aspect, the chemical resistant layer contains from 5 to 50 weight percent of impact modifier, and preferably from 10 to 40 weight percent, based on the total matrix polymer.

In a twelfth aspect, the cap layer, and/or said chemical resistant layer comprises from 0.2 to 5 weight percent of one or more UV absorbers.

In a thirteenth aspect, the weatherable, chemical resistant pultruded structure of the above aspect forms part of an article.

In a fourteenth aspect, the article is selected from the group consisting of window profiles, doors, door profiles, playground equipment, utility poles, and sea walls.

In a fifteenth aspect, a process for forming the weatherable, chemical resistant pultruded structure of the above aspects is presented, comprising the steps of:
a) forming a fiber-reinforced structure using a pultrusion process,
b) optionally applying one or more tie layers to the pultruded structure,
c) adhering one or more cap layers to said pultruded structure,
d) adhering a chemical resistant layer to said pultruded structure.

In a sixteenth aspect, the optional tie layer(s), cap layers and chemical resistant layer are coextruded onto said pultruded structure.

In a seventeenth aspect, the chemical resistant layer is applied to said cap stock by coextrusion, film lamination, extrusion-lamination, insert molding, multi-shot injection molding, or compression molding.

In an eighteenth aspect, the cap layer is coated with a radiation curable coating, followed by extruding said one or more cap layers, followed by radiation curing the coating using LED, e-beam, or gamma radiation.

### DETAILED DESCRIPTION OF THE INVENTION

The weatherable and chemical resistance pultruded structure of the invention involves a thermoset or thermoplastic pultruded structure, covered with a cap layer, and having a chemical resistant outerlayer.

As used herein copolymer refers to any polymer having two or more different monomer units, and would include terpolymers and those having more than three different monomer units.

Molecular weights are given as weight average molecular weights, as measured by GPC

Percentages are given as weight percents, unless otherwise noted.

The references cited in this application are incorporated herein by reference.

The invention relates to a multi-layer structure having a pultruded substrate, a tie layer(s) and a weatherable outer layer. The invention further relates to a process for adhering a protective thermoplastic capstock to a pultruded substrate through the use of one or more tie-layers.

### Pultruded Substrate

The pultruded substrate is a fiber-reinforced thermoset or thermoplastic resin, produced by pulling a blend of fibers and the liquid resin through a die—as known in the art. The thermoset or thermoplastic resin systems impregnate and coat the fibers, to produce a strong composite material once cured.

Useful fibers include those known in the art, including but are not limited to both natural and synthetic, fibers, fabrics, and mats, such as glass fibers, carbon fibers, graphite fibers, carbon nanotubes, and natural fibers such as hemp, bamboo or flax. Glass fibers, treated or untreated, are a preferred fiber.

Useful thermoset resins include, but are not limited to, alkyds, diallyl phthalates, epoxies, melamines and ureas, phenolics, polyurethanes and polyesters, maleimides, bismaleimdies, acrylics. Particularly preferred thermoset resins are polyesters and polyurethane.

In one embodiment, due to its higher modulus, and cost, polyurethane is an especially preferred resin for use in the present invention. Polyurethane (PU) pultruded structures of the invention provide an increased modulus over polyester pultruded structures, making the weatherable PU pultrusion useful in commercial applications, and applications requiring a higher transverse modulus.

Useful thermoplastic resin systems include ELIUM® liquid resins systems from Arkema, The ELIUM® resin system is one having:
(a) a polymeric thermoplastic (meth)acrylic matrix, consisting of at least one acrylic copolymer comprising at least 70% by weight of methyl methacrylate monomer units and from 0.3 to 30% by weight of at least one monomer having at least one ethylenic unsaturation that can copolymerize with methyl methacrylate;
(b) at least 30 weight percent of a fibrous material, based on the total weight of the polymeric composite material as reinforcement, wherein the fibrous material comprises either a fiber with an aspect ratio of the fiber of at least 1000, or the fibrous material has a two dimensional macroscopic structure;
(c) an initiator system.

In addition to the fibers and resin, other additives can be added to the pultruded structure composition, including but not limited to low profile additives (acrylics, poly vinyl acetate), acrylic beads, fillers, low molecular weight acrylic process aids—such as low molecular weight (less than 100,000, preferably less than 75,000 and more preferably less than 60,000 molecular weight), and low viscosity or low Tg acrylic resins (Tg<50° C.).

Polymers, such as polyamides, block copolymers or other thermoplastics including acrylonitrile-butadiene-styrene (ABS), polyvinyl chloride (PVCO, high impact polystyrene (HIPS), acrylonitrile-styrene-acrylate (ASA), and polylactic acid (PLA), can be added to the pultruded substrate to allow domains/ chemical functionalities to facilitate chemical adhesion or increase surface roughness to facilitate mechanical adhesion.

The surface of the pultruded structure may be altered physically (by the addition of polymer or glass beads, or roughening) or chemically (corona, flame or plasma treatment). The chemistry of the pultruded resin itself can be manipulated to improve adhesion, for example, by adjusting the ratio of the isocyanate and polyol in a polyurethane pultruded structure to provide more polyol ends—which could react with a polyamide tie layer; or by adding reactive groups into the thermoset polymer.

Further, a resin-rich skin could be produced by increasing the resin to fiber ratio in the outer layer of the pultruded structure, and thus improve adhesion.

### Tie Layer

A tie layer between the pultruded structure and a cap layer is optional in the case of a polyester structure, but is needed for a polyurethane structure. In the case of an acrylic thermoplastic composite, there is no need for an additional tie layer.

Tie layers that can be used to not only provide improved weatherability and appearance for polyester and other commonly used capped pultrusion structures, but can also provide adhesion between a polyurethane-based pultrusion and a capping layer.

Tie layers or adhesion layers between the pultruded substrate and the cap layer(s) adhere the substrate and cap layer together. The tie layer or layers will be from 0.01 to 0.3 mm, and preferably from 0.02 to 0.15 mm in thickness.

The tie layer is selected for affinity to one or both substrate and cap layer. In the case of multiple tie layers, the first is selected for its affinity to the pultruded substrate (and the second tie layer), while the second tie layer is selected for its affinity to the cap layer (and the first tie layer). Useful extrudable tie layers include, but are not limited to, thermoplastics including polyamides, copolyamides, block copolymers of polyamide and polyester; acrylic, stryrenic or butadiene-based block copolymers, functionalized olefins, functionalized acrylics, polylactic acid (PLA) and ABS.

A particularly preferred tie layer is a copolyamide blend made up of two or more different and varying polyamide repeat units (6; 6,6; 12; 11; etc). While not being bound by any particular theory, it is believed that a random copolyamide blend retards crystallization, while providing good adhesion to a variety of materials—including polyurethane, acrylics and styrenics. One specific useful extrudable polyamide adhesive blend is sold under the tradename of PLATAMID® by Arkema Inc. In one preferred embodiment, the melting point of the copolyamide or copolyamide blend is <150 ° C.

In order to further improve adhesion, the viscosities of the extruded layers should be relatively the same, with the complex viscosity delta (as measured by rotational viscosity at 10 Hz) of the cap and tie layer being preferably less than 1000 Pa·s and more preferably less than 300 Pa·s. The viscosity of each extruded layer can be adjusted by controlling the extrusion barrel temperature. In one preferred embodiment, the extrusion barrel temperature of the tie layer is at least 10° C., and most preferably at least 30° C. lower than the extrusion barrel temperature of the capstock layer. The viscosities of the extruded layer may also be adjusted by the formulation of the extrudable tie layer. Increasing the MW of the polymeric tie layer, incorporation of high mw polymer, addition of cross-linked organic polymer such as core shell impact modifiers or addition of inorganic filler are some ways to increase the viscosity of the extruded layer but my no means constitute an exhaustive list.

The extrudable adhesive layer is in the range of 0.05 to 0.3 mm, preferably from 0.075 to 0.15 mm in thickness.

Another useful tie layer is a coating that can be activated by radiation through free radical polymerization. For example, a UV/EB-curable acrylic composition, comprising acrylic oligomer and monomer, such as available from Sartomer, can be directly applied by roll coating, curtain coating, or spraying directly onto the pultruded structure followed by curing via a UV lamp source, with the cap layer extruded immediately after the lamp. Since the cap layer will be resistant to UV radiation, it is not possible to activate the tie layer through the cap layer following extrusion of the cap layer.

An alternative would be to use a radiation curable adhesive that can be activated through a UV-opaque material, in a system similar to that described in WO 13/123,107. In this case, the adhesive tie-layer could be sprayed onto the pultruded substrate, followed by extrusion of the thermoplastic cap layer, followed by a cure of the tie layer by LED or e-beam radiation. The adhesive composition includes a reactive oligomers, functional monomers, and photoinitiator (for use with photon radiation sources).

In a preferred embodiment, the radiation curable adhesive composition contains one or more aliphatic urethane (meth)acrylates based on polyester and polycarbonate polyols, in combination with mono- and multifunctional (meth)acrylate monomers. Alternately, the oligomer can include mono or multifunctional (meth)acrylate oligomers having polyesters and/or epoxy backbones, or aromatic oligomers alone or in combination with other oligomers.

Non-reactive oligomers or polymers could also be used in conjunction with (meth)acrylate functional monomers and/or oligomers. The viscosity of the liquid adhesive composition can be adjusted by the choice of, and concentration of oligomers to monomers in the composition.

Aliphatic urethane acrylates based off polyester and polycarbonate polyols are preferred.

The aliphatic urethane acrylates generally have a molecular weight of from 500 to 20,000 daltons; more preferably between 1,000 and 10,000 daltons and most preferably from 1,000 to 5,000 daltons. If the MW of the oligomer is too great, the crosslink density of the system is very low creating an adhesive that has a low tensile strength. Having too low of a tensile strength causes problems when testing peel strength as the adhesive may fail prematurely.

The content of aliphatic urethane oligomer in the oligomer/monomer blend should be 5% to 80% by weight; more preferably 10% to 60% by weight and most preferably from 20% to 50% by weight.

The radiation cured adhesive layer is in the range of 0.01 to 0.04 mm, preferably from 0.02 to 0.03 mm in thickness.

The photoinitiator is one that absorbs photons to produce free radicals that will initiate a polymerization reaction. Useful photoinitiators of the invention include, but are not limited to bis acyl phosphine oxides (BAPO), and trimethyl-diphenyl-phosphineoxides (TPO), 2-hydroxy-2-methyl-1-phenyl-1-propanone and other a-hydroxy ketones, benzophenone and benzophenone derivates, and blends thereof.

The photoinitiator is present in the adhesive tie composition at 0.2 to 6.0 weight percent based on the total of the adhesive composition, preferably from 0.5 to 5.0 percent by weight. In the alternative, if electron beam radiation is used for the curing, no photoinitiator is needed.

An aqueous based emulsion can also be considered as a tie layer, preferably an acrylic based emulsion.

The tie layer(s) of the invention may be optimized by adding reactive chemical functionalities as additives or comonomers (acid, anhydide, alcohol, glycidyl, piperazine, urea, ether, ester) or adding acrylic beads, fillers, low molecular weight acrylic process aids, low viscosity or low Tg acrylic resins, polyamides, block copolymers or other thermoplastics (ABS, PVC, HIPS, ASA, PLA) to improve adhesion either via chemical or mechanical (surface roughness) mechanisms. Reactive groups can also be incorporated into the layer in contact with the polyurethane (PU) so that they react with the unreacted groups (isocyanates or polyols) on the PU, promoting adhesion. In this case, preferably, the cross head die should be kept as close to the pultrusion die as possible to maximize the number of available reactive groups available when the coextrusion takes place.

Incorporation of 0 to 60% of high molecular weight polymers (Mw>100,000), cross-linked polymeric systems (such as core shell impact modifiers), inorganic fillers or other rheological additives may alter the viscosity of the tie layer, potentially leading to improved adhesion.

Incorporation of 0 to 60% of core shell impact modifiers (preferably acrylic) may also improve the toughness and ductility of the tie layer, potentially critical for any application where residual stress in the fabricated part could lead to cracking during assembly/installation or due to exposure to the elements in outdoor applications.

In certain cases where exposure to water/ water vapor at elevated temperatures is critical for the application, it may be desirable to decrease the hydrophilicity of the tie layer, to prevent water absorption. In these cases, it may be advantageous to alloy a hydrophilic tie layer (such as a copolyamide) with 0 to 60% of a more hydrophobic materials such as olefins, styrenics, acrylics or core shell polymers.

In certain cases where exposure to high temperatures is required, it may be advantageous to alloy the tie layer with polymers having higher thermal properties- via a higher melting point or higher glass transition point. In other cases, where shrinkage of the tie layer is problematic, it may be advantageous to alter the percent crystallinity of a semi-crystalline polymeric tie layer, using alloys with 0 to 60% of either miscible or immiscible polymers or 0 to 60% inorganic or organic sub-micron particles that may either serve as either nucleating agents or crystallinity suppressors as needed for the application.

### Cap Layer

A cap layer or layers is applied on the pultruded substrate, or over a tie layer, if present. The cap layer may be directly applied in-line by a spray, aqueous or solvent coating, or by an extrusion process—with an extrusion process being preferred. The cap layer, and optional tie layer, could also be applied in one or more separate steps, such as by a coating, compression molding, roto-molding, lamination, or overmolding (injection molding) processes.

The cap layer(s) have a thickness of between 0.0025 and 1 mm, preferably between 0.005 and 0.5 mm.

Useful cap layer polymers include, but are not limited to styrenic-based polymers, acrylic-based polymers, vinylic polymers, polyesters, polycarbonate and thermoplastic polyurethane (TPU). Preferred cap layer polymers are styrenic and/or acrylic-based.

The acrylic-based layer comprises either an acrylic polymer, or a vinyl cyanide-containing compound, for example an acrylonitrile-butadiene-styrene (ABS) copolymer, an acrylonitrile-styrene-acrylate (ASA) copolymer, or styrene acrylonitrile (SAN) copolymer. “Acrylic polymer” as used herein is meant to include polymers, copolymers and terpolymers formed from alkyl methacrylate and alkyl acrylate monomers, and mixtures thereof. The alkyl methacrylate monomer is preferably methyl methacrylate, which may make up from 50 to 100 percent of the monomer mixture. 0 to 50 percent of other acrylate and methacrylate monomers or other ethylenically unsaturated monomers, included but not limited to, styrene, alpha methyl styrene, acrylonitrile, and crosslinkers at low levels may also be present in the monomer mixture. Suitable acrylate and methacrylate comonomers include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. Alkyl (meth) acrylic acids such as methacrylic acid and acrylic acid can be useful for the monomer mixture. Most preferably the acrylic polymer is a copolymer having 70-99.5 weight percent of methyl methacrylate units and from 0.5 to 30 weight percent of one or more C₁₋₈ straight or branched alkyl acrylate units.

Styrenic-based polymers include, but are not limited to, polystyrene, high-impact polystyrene (HIPS), acrylonitrile-butadiene-styrene (ABS) copolymers, acrylonitrile-styrene-acrylate (ASA) copolymers, styrene acrylonitrile (SAN) copolymers, methacrylate-butadiene-styrene (MBS) copolymers, styrene-butadiene-styrene block (SBS) copolymers and their partially or fully hydrogenenated derivatives, styrene-isoprene-styrene (SIS) block copolymers and their partially or fully hydrogenenated derivatives, and styrene-methyl methacrylate copolymers (S/MMA). A preferred styrenic polymer is ASA or ABS. The styrenic polymers of the invention can be manufactured by means known in the art, including emulsion polymerization, solution polymerization, and suspension polymerization. Styrenic copolymers of the invention have a styrene content of at least 10 percent by weight, preferably at least 25 percent by weight.

In one embodiment, the cap layer polymer has a weight average molecular weight of between 50,000 and 500,000 g/mol, preferably from 75,000 to 250,000 g/mol, more preferably 90,000 g/mol to 150,000 g/mol, and more preferably 105, 000 g/mol to 150,000 g/mol, as measured by gel permeation chromatography (GPC). The molecular weight distribution of the acrylic polymer is monomodal or multimodal and the polydispersity index is higher than 1.5.

In another embodiment, the cap layer(s) of the invention may be optimized for adhesion by adding reactive chemical functionalities as additives or comnomers or adding acrylic beads, fillers, low molecular weight acrylic process aids, low viscosity or low Tg acrylic resins, polyamides, block copolymers or other thermoplastics (ABS, PVC, HIPS, ASA, PLA)

Other typical additives may also be added to one or more of the tie or cap layers, including but not limited to impact modifiers, fillers or fibers, or other additives of the type used in the polymer art. Examples of impact modifiers include, but are not limited to, core-shell particles—with either a hard or soft core, and block or graft copolymers. Examples of useful additives include, for example, UV light inhibitors or stabilizers, lubricant agents, heat stabilizers, flame retardants, synergists, pigments and other coloring agents. Examples of fillers employed in a typical compounded polymer blend according to the present invention include talc, calcium carbonate, mica, matting agents, wollastonite, dolomite, glass fibers, boron fibers, carbon fibers, carbon blacks, pigments such as titanium dioxide, or mixtures thereof. In one embodiment, an acrylic or styrenic cap layer is blended with a 5 to 80 wt %, preferably 10 to 40 wt %, of a polyvinylidene fluoride polymer or copolymer thereof, or with an aliphatic polyester—such as polylactic acid. The polyvinylidene additive acts as a filler, and provides some flame-resistance to the cap layer.

In one preferred embodiment, calcium carbonate at a level from 2 to 40, and preferably from 7 to 25 weight percent based on the level of polymer, is added to an acrylic polymer for improved adhesion to a polyester pultruded structure.

In a preferred embodiment, UV absorbers are present in either the cap layer, the chemical resistant layer, or both. UV absorbers are generally present at from 0.5 to 3 weight percent and preferably 0.7 to 1.5 weight percent, based on the total level of polymer.

Examples of matting agents include, but are not limited to, cross-linked polymer particles of various geometries. The amount of filler and additives included in the polymer compositions of each layer may vary from about 0.01% to about 70% of the combined weight of polymer, additives and filler. Generally, amounts from about 5% to about 45%, from about 10% to about 40%, are included.

Pigmented pultruded structures are especially useful. The pigment in such a structure may be placed in the tie layer, and/or in one or more cap layers. In a preferred embodiment, the outermost layer contains very few, if any additives—as many additives can decrease the weatherability. A preferred embodiment is to place pigment and other additives in a first cap layer, covered by a clear outermost weatherable layer.

### Chemical Resistant Layer

In one embodiment, a thin (less than 0.5 mm and preferably less than 0.25 mm) fluoropolymer-rich layer is provided on top of the cap layer to improve chemical resistance. A fluoropolymer-rich layer is a miscible blend of 51 to 95 weight percent, preferably 60 to 93 weight percent, and more preferably 70 to 90 weight percent of a fluoropolymer, preferably a polyvinylidene fluoride homopolymer or copolymer with one or more (meth)acrylic polymers. The fluoropolymer has a better chemical resistance than a pure (meth)acrylic polymer, and the blended (meth)acrylic polymer provides better adhesion properties with the cap layer than a fluoropolymer. The polyvinylidene fluoride polymer preferably contains greater than 60 weight percent, and more preferably greater than 75 weight percent of vinylidene fluoride monomer units. The (meth)acrylic polymers preferably are high molecular weight, for increased chemical resistance, having a molecular weight of from 50,000 g/mol to 500,000 g/mol, preferably 75,000 g/mol to 250,000 g/mol, more preferably 90,000 g/mol to 150,000 g/mol, and more preferably 105,000 g/mol to 150,000 g/mol. The (meth)acrylic polymer is preferably less than 500,000 g/mol for good processing. (Meth)acrylic polymer in the chemical resistant layer preferably has a high T_{g} of greater than 100° C., greater than 105° C., and preferably greater than 110° C., greater than 115° C., and even greater than 120° C. The glass transition temperature, is measured at a heating rate of 10° C./minute in a DSC in N₂,

In one embodiment, the acrylic polymer in the chemical resistant layer contains 0.1 to less than 10 weight percent, and preferably from 0.2 to 5 weight percent of an acid-containing monomer, and preferably acrylic acid of methacrylic acid monomer units. The acid monomer makes the (meth)acrylic copolymer hydrophilic—which helps resist chemicals that are hydrophobic.

In a preferred embodiment, the chemical resistant layer is impact modified, containing from 5 to 50 weight percent of impact modifier, and preferably from 10 to 40 weight percent, based on the total matrix polymer. The impact modifier may be a rubber, a block copolymer, core-shell polymers, or a mixture thereof. Hard-core, core-shell impact modifiers are especially preferred.

In another embodiment, the outer chemical resistant layer is a radiation-curable acrylic or styrenic polymer. This outer layer is generally an additional layer on top of the cap layer, though in one embodiment the radiation-curable acrylic or styrenic polymer is blended into the cap layer, and no additional outer layer is present.

The radiation-curable layer may be applied as a coating, or as part of a multi-layer coextrusion.

### Free Radically-Curable Ethylenically Unsaturated Compounds

Ethylenically unsaturated compounds suitable for use in the free radically-curable component of the compositions of the present invention include compounds containing at least one carbon-carbon double bond, in particular a carbon-carbon double bond capable of participating in a free radical reaction wherein at least one carbon of the carbon-carbon double bond becomes covalently bonded to an atom, in particular a carbon atom, in a second molecule. Such reactions may result in a polymerization or curing whereby the ethylenically unsaturated compound becomes part of a polymerized matrix or polymeric chain. In various embodiments of the invention, the ethylenically unsaturated compound may contain one, two, three, four, five or more carbon-carbon double bonds per molecule. In certain embodiments, the free radical curable component of the inventive composition comprises, consists essentially of or consists of at least one ethylenically unsaturated compound containing at least two carbon-carbon double bonds per molecule. In other embodiments, the free radical curable component of the inventive composition comprises, consists essentially of or consists of at least one ethylenically unsaturated compound containing at least three carbon-carbon double bonds per molecule.

Combinations of multiple ethylenically unsaturated compounds containing different numbers of carbon-carbon double bonds may be utilized in the compositions of the present invention. The carbon-carbon double bond may be present as part of an α, β-unsaturated carbonyl moiety, e.g., an α, β-unsaturated ester moiety such as an acrylate functional group or a methacrylate functional group. A carbon-carbon double bond may also be present in the ethylenically unsaturated compound in the form of a vinyl group —CH═CH₂ (such as an allyl group, —CH₂—CH═CH₂). Two or more different types of functional groups containing carbon-carbon double bonds may be present in the ethylenically unsaturated compound. For example, the ethylenically unsaturated compound may contain two or more functional groups selected from the group consisting of vinyl groups (including allyl groups), acrylate groups, methacrylate groups and combinations thereof.

The compositions of the present invention may, in various embodiments, contain one or more (meth)acrylate functional compounds capable of undergoing free radical polymerization (curing). As used herein, the term “(meth)acrylate” refers to methacrylate (—O—(═O)—C(CH₃)═CH₂) as well as acrylate (—O—C(═O)—CH═CH₂) functional groups. Suitable free radical-curable (meth)acrylates include compounds containing one, two, three, four or more (meth)acrylate functional groups per molecule; the free radical-curable (meth)acrylates may be oligomers or monomers.

The total amount of free radical-curable ethylenically unsaturated compound (component (c)) in the composition relative to the total amount of fluoropolymer (component (a)) and polymer (component (b)) which is present is not believed to be particularly critical, but generally is selected to be an amount effective to improve at least one characteristic of the composition as compared to a composition containing the same components (a) and (b) but not any free radical-curable ethylenically unsaturated compound.

A wide variety of different types of free radical-curable ethylenically unsaturated compounds may be used in the compositions of the present invention, including for example (meth)acrylated polyols and (meth)acrylated alkoxylated polyols as well as other types of (meth)acrylate oligomers and (meth)acrylate monomers.

### Free Radical-Curable (Meth)Acrylated Polyols and (Meth)Acrylated Alkoxylated Polyols

In certain embodiments of the invention, the free radically-curable component of the composition comprises, consists essentially of or consists of one or more (meth)acrylated polyols and/or (meth)acrylated alkoxylated polyols (in particular, one or more acrylated ethoxylated and/or propoxylated polyols). The polyol moiety present in such compounds may be based on any organic compound containing two or more hydroxyl groups per molecule, including for example diols (e.g., glycols such as 2-neopentyl glycol), triols (e.g., glycerin, trimethylolpropane), tetrols (e.g., pentaerythritol). One or more of the hydroxyl groups of the polyol may be substituted with a (meth)acrylate functional group, in particular an acrylate functional group (—OC(═O)CH═CH₂). All of the polyol hydroxyl groups may be (meth)acrylated, in certain embodiments of the invention. In other embodiments, the hydroxyl groups of the polyol are alkoxylated by reaction with an alkylene oxide such as ethylene oxide, propylene oxide or a combination thereof. One or more (in one embodiment, all) of the hydroxyl groups resulting from alkoxylation of the polyol are substituted with a (meth)acrylate functional group, in particular an acrylate functional group. The degree of alkoxylation may be varied as may be desired; for example, the (meth)acrylated alkoxylated polyol may contain 1 to 20 oxyalkylene units (e.g., —CH₂CH₂O—, —CH₂CH(CH₃)O—) per polyol moiety.

Illustrative examples of suitable acrylated polyols and acrylated alkoxylated polyols include, but are not limited to, ethoxylated pentaerythritol tetraacrylates, ethoxylated trimethylolpropane triacrylates, trimethylolpropane triacrylates, propoxylated glyceryl triacrylates, propoxylated 2-neopentyl glycol diacrylates, and combinations thereof.

### Free Radical-Curable (Meth)Acrylate Oligomers

Suitable free radical-curable (meth)acrylate oligomers include, for example, polyester (meth)acrylates, epoxy (meth)acrylates, polyether (meth)acrylates, polyurethane (meth)acrylates and combinations thereof.

Exemplary polyester (meth)acrylates include the reaction products of acrylic or methacrylic acid or mixtures thereof with hydroxyl group-terminated polyester polyols. The reaction process may be conducted such that a significant concentration of residual hydroxyl groups remain in the polyester (meth)acrylate or may be conducted such that all or essentially all of the hydroxyl groups of the polyester polyol have been (meth)acrylated. The polyester polyols can be made by polycondensation reactions of polyhydroxyl functional components (in particular, diols) and polycarboxylic acid functional compounds (in particular, dicarboxylic acids and anhydrides). The polyhydroxyl functional and polycarboxylic acid functional components can each have linear, branched, cycloaliphatic or aromatic structures and can be used individually or as mixtures.

Examples of suitable epoxy (meth)acrylates include the reaction products of acrylic or methacrylic acid or mixtures thereof with glycidyl ethers or esters.

Suitable polyether (meth)acrylates include, but are not limited to, the condensation reaction products of acrylic or methacrylic acid or mixtures thereof with polyetherols which are polyether polyols. Suitable polyetherols can be linear or branched substances containing ether bonds and terminal hydroxyl groups. Polyetherols can be prepared by ring opening polymerization of cyclic ethers such as tetrahydrofuran or alkylene oxides with a starter molecule. Suitable starter molecules include water, hydroxyl functional materials, polyester polyols and amines.

Polyurethane (meth)acrylates (sometimes also referred to as “urethane (meth)acrylates”) capable of being used in the compositions of the present invention include urethanes based on aliphatic and/or aromatic polyester polyols and polyether polyols and aliphatic and/or aromatic polyester diisocyanates and polyether diisocyanates capped with (meth)acrylate end-groups.

In various embodiments, the polyurethane (meth)acrylates may be prepared by reacting aliphatic and/or aromatic diisocyanates with OH group terminated polyester polyols (including aromatic, aliphatic and mixed aliphatic/aromatic polyester polyols), polyether polyols, polycarbonate polyols, polycaprolactone polyols, polydimethysiloxane polyols, or polybutadiene polyols, or combinations thereof to form isocyanate-functionalized oligomers which are then reacted with hydroxyl-functionalized (meth)acrylates such as hydroxyethyl acrylate or hydroxyethyl methacrylate to provide terminal (meth)acrylate groups. For example, the polyurethane (meth)acrylates may contain two, three, four or more (meth)acrylate functional groups per molecule.

One or more urethane diacrylates are employed in certain embodiments of the invention. For example, the composition may comprise at least one urethane diacrylate comprising a difunctional aromatic urethane acrylate oligomer, a difunctional aliphatic urethane acrylate oligomer and combinations thereof. In certain embodiments, a difunctional aromatic urethane acrylate oligomer, such as that available from Sartomer USA, LLC (Exton, Pennsylvania) under the trade name CN9782, may be used as the at least one urethane diacrylate. In other embodiments, a difunctional aliphatic urethane acrylate oligomer, such as that available from Sartomer USA, LLC under the trade name CN9023 , may be used as the at least one urethane diacrylate. CN9782, CN9023, CN978, CN965, CN9031, CN8881, and CN8886, all available from Sartomer USA, LLC, may all be advantageously employed as urethane diacrylates in the compositions of the present invention.

### Free Radical-Curable (Meth)acrylate Monomers

Illustrative examples of suitable free radical-curable ethylenically unsaturated monomers include 1,3-butylene glycol di(meth)acrylate, butanediol di(meth)acrylate, 1,6-hexanediol di(meth)acrylate, alkoxylated hexanediol di(meth)acrylate, alkoxylated aliphatic di(meth)acrylate, alkoxylated neopentyl glycol di(meth)acrylate, dodecyl di(meth) acrylate cyclohexane dimethanol di(meth)acrylate, diethylene glycol di(meth)acrylate, dipropylene glycol di(meth)acrylate, n-alkane di(meth) acrylate, polyether di(meth) acrylates, ethoxylated bisphenol A di(meth)acrylate, ethylene glycol di(meth)acrylate, neopentyl glycol di(meth)acrylate, polyester di(meth)acrylate, polyethylene glycol di(meth)acrylate, polypropylene glycol di(meth)acrylate, propoxylated neopentyl glycol diacrylate, tricyclodecane dimethanol diacrylate, triethylene glycol di(meth)acrylate, tetraethylene glycol di(meth)acrylate tripropylene glycol di(meth)acrylate, ditrimethylolpropane tetra(meth)acrylate, dipentaerythritol penta(meth)acrylate, ethoxylated pentaerythritol tetra(meth)acrylate, dipentaerythritol penta(meth)acrylate, dipentaerythritol penta(meth)acrylate, penta(meth)acrylate ester, pentaerythritol tetra(meth)acrylate, ethoxylated trimethylolpropane tri(meth)acrylate, alkoxylated trimethylolpropane tri(meth)acrylate, highly propoxylated glyceryl tri(meth)acrylate, trimethylolpropane tri(meth)acrylate, trimethylolpropane tri(meth)acrylate, pentaerythritol tri(meth)acrylate, propoxylated glyceryl tri(meth)acrylate, propoxylated trimethylolpropane tri(meth)acrylate, trimethylolpropane trimethacrylate, tris (2-hydroxy ethyl) isocyanurate tri(meth)acrylate, 2(2-ethoxyethoxy) ethyl (meth)acrylate, 2-phenoxyethyl (meth)acrylate, 3,3,5-trimethylcyclohexyl (meth)acrylate, alkoxylated lauryl (meth)acrylate, alkoxylated phenol (meth)acrylate, alkoxylated tetrahydrofurfuryl (meth)acrylate, caprolactone (meth)acrylate, cyclic trimethylolpropane formal (meth)acrylate, cycloaliphatic acrylate monomer, dicyclopentadienyl (meth)acrylate, diethylene glycol methyl ether (meth)acrylate, ethoxylated (4) nonyl phenol (meth)acrylate, ethoxylated nonyl phenol (meth)acrylate, isobornyl (meth)acrylate, isodecyl (meth)acrylate, isooctyl (meth)acrylate, lauryl (meth)acrylate, methoxy polyethylene glycol (meth)acrylate, octyldecyl (meth)acrylate, stearyl (meth)acrylate, tetrahydrofurfuryl (meth) acrylate, tridecyl (meth)acrylate, and/or triethylene glycol ethyl ether (meth)acrylate, t-butyl cyclohexyl (meth)acrylate, alkyl (meth)acrylate, dicyclopentadiene di(meth)acrylate, alkoxylated nonylphenol (meth)acrylate, phenoxyethanol (meth)acrylate, octyl (meth)acrylate, decyl (meth)acrylate, dodecyl (meth)acrylate, tetradecyl (meth)acrylate, tridecyl (meth)acrylate, cetyl (meth)acrylate, hexadecyl (meth)acrylate, behenyl (meth)acrylate, diethylene glycol ethyl ether (meth)acrylate, diethylene glycol butyl ether (meth)acrylate, triethylene glycol methyl ether (meth)acrylate, dodecanediol di (meth)acrylate, dodecane di (meth)acrylate, dipentaerythritol penta/hexa(meth)acrylate, pentaerythritol tetra(meth)acrylate, ethoxylated pentaerythritol tetra(meth)acrylate, ethoxylated trimethylolpropane tri(meth)acrylate, trimethylolpropane tri(meth)acrylate, di-trimethylolpropane tetra(meth)acrylate, propoxylated glyceryl tri(meth)acrylate, pentaerythritol tri(meth)acrylate, propoxylated glyceryl tri(meth)acrylate, propoxylated trimethylolpropane tri(meth)acrylate, trimethylolpropane tri(meth)acrylate, and tris (2-hydroxy ethyl) isocyanurate tri(meth)acrylate, and combinations thereof.

Moreover, one can also use UV curable acrylic coatings (for example, products from Sartomer) or acrylic capstock resins that is formulated with stabilized di-acrylic or multifunctional acrylate or methacrylate monomers that acts as crosslinkers and can be activated (reacted) after the extrusion step with an in-line UV or e-beam source. In both of these cases, the chemical resistance of the acrylic cap layer is achieved by crosslinking the matrix.

At least one photoinitiator curable with radiant energy is included in the radiation-curable composition. For example, the photoinitiator(s) may include, but is not limited to photoinitiators of α-hydroxyketones, phenylglyoxylates, benzyldimethylketals, α-aminoketones, mono-acyl phosphines, bis-acyl phosphines, phosphine oxides, metallocenes and combinations thereof. In particular embodiments, the at least one photoinitiator may be 1-hydroxy-cyclohexyl-phenyl-ketone and/or 2-hydroxy-2-methyl-1-phenyl-1-propanone.

### Process

The chemical resistant layer may be applied to the capped, pultruded structure in several ways. The outermost layer could be applied through film lamination, extrusion-lamination, insert molding, multi-shot injection molding, and compression molding.

The chemical resistant layer could be formed as a solvent or aquoues coating, and applied by typical means such as spraying, brushing, knife coating, roller coating, casting, drum coating, dipping, and the like and combinations thereof. In a preferred embodiment, the chemical resistant coating is an aqueous PVDF/acrylic coating, such as AQUATEC® coatings from Arkema. The advantage of coatings is customizability for different colors/surfaces/product lines, and disadvantage would include an extra labor-intensive step to apply the coatings, as compared to a one-step continuous co-extrusion process and less scratch and mar resistance due to a thinner cap layer.

### Uses

The weatherable, capped, pultruded substrate of the invention is useful as a replacement for wood and metal structures and parts. Typical uses include: window profiles (residential and commercial), windows, doors, door profiles, fencing, decking, railings, skylight framings, commercial curtainwall used in skyscrapers. Because of its weatherability, increased modulus, and lighter weight, capped pultruded polyurethane could replace coated metal, and especially coated aluminum in playground equipment, ladders, commercial building materials, truck and car parts, recreational vehicle parts, public transport vehicle parts, agricultural vehicle parts, sea walls, utility poles, lamp posts, and ladders.

### EXAMPLES

### Example 1

The following capstock layer polymer blends listed in Table 1 were prepared by melt-blending the components in a twin screw extruder operating at 300 rpm with the typical processing temperatures listed in Table 2.

TABLE 1
Capstock Compositions

| | Capstock 1 | Capstock 2 | | | |
|---|---|---|---|---|---|
| | (Comparative | (Comparative | Capstock 3 | Capstock 4 | Capstock 5 |
| Ingredient | Example) | Example) | (Invention) | (Invention) | (Invention) |
| Acrylic polymer blend | 100 | 72 | 30 | 20 | 10 |
| PVDF Polymer | 0 | 28 | 70 | 80 | 90 |

TABLE 2
Processing temperatures of twin screw extruder

| Zone 1 | Zone 2 | Zone 3 | Zone 4 | Zone 5 | Zone 6 | Zone 7 | Zone 8 | Zone 9 | Die |
|---|---|---|---|---|---|---|---|---|---|
| 140° C. | 160° C. | 190° C. | 200° C. | 200° C. | 200° C. | 200° C. | 210° C. | 210° C. | 234° C. |

### Example 2

The capstock compositions listed in Example 1 were injection molded into 50.8 mm×76.2 mm×3.175 mm plaques with a Sumitomo Demag Systec 40/120 Injection Molding Machine operating at 125 rpm, with a packing pressure of 1025 psi and 25 seconds hold time. The typical processing temperatures are listed in Table 3.

TABLE 3
Processing temperatures of injection molder

| Mold | Feed Throat | Zone 1 | Zone 2 | Zone 3 | Nozzel |
|---|---|---|---|---|---|
| 37.8° C. | 57.2° C. | 221° C. | 221° C. | 221° C. | 221° C. |

### Example 3

The chemical resistance of the compression molded plaques in Examples 2 were tested by placing the samples onto a constant strain fixture at 0.5% strain at room temperature and evaluated over the course of 24 hours. A 50% isopropyl alcohol solution was used to screen chemical resistance, with failure occurring when any craze or crack was seen. Five droplets of this solution were placed on the apex of the samples every 15 minutes for the first hour, and every hour thereafter. Samples containing less than 30% PVDF content failed within the first hour, with higher PVDF content showing no damage after 24 hours. Results are summarized in Table 4.

TABLE 4
Chemical Resistance of Molded Plaques

| | Capstock 1 | Capstock 2 | | | |
|---|---|---|---|---|---|
| | (Comparative | (Comparative | Capstock 3 | Capstock 4 | Capstock 5 |
| Ingredient/Properties | Example) | Example) | (Invention) | (Invention) | (Invention) |
| PVDF content | 0% | 28% | 70% | 80% | 90% |
| Time to Failure | <30 minutes | <15 minutes | >24 hours | >24 hours | >24 hours |

Table 4 demonstrates the advantage in chemical resistance when the outermost layer of a multilayer system uses a fluoropolymer rich polymer blend as the top surface (capstock layer).

### Example 4

A chemical resistant pultruded structure can be prepared by a co-extrusion process with a crosshead co-extrusion die. In the case of a three layer structure, one would extrude the outermost chemical resistant layer of a fluoropolymer rich blends such as Capstock 5 with a single-screw extruder at 180-240° C., and one would extrude the thermoplastic cap layer of acrylic resin at 200-250° C. with another single screw extruder. Simultaneous, one would co-extrude the two layers previously described onto the substrate layer of pultruded fiber-reinforced polyester resin with a crosshead co-extrusion die. The crosshead die is typically attached to the extruders through an adaptor pipe. The entrance to the die is usually fitted to the pultruded part, therefore centering the part in the die. Once co-extruded, the chemical resistant pultruded structure would go through a puller system where urethane or rubber grips are used instead of metal clamping devices to avoid damages to the surface. The final multilayer structure may be directly extruded in a profile shape (for example for window and door profiles, fencing, decking, railing, and skylight framings), or extruded into a sheet form and then thermoformed into a final shape (for example for playground equipment, ladders, truck and car parts, recreational vehicle parts, lamp posts, ladders, and utility poles).

1. A weatherable, chemical resistant pultruded structure comprising, in order from the inside to the outside:
a) a pultruded structure comprising a fiber-reinforced thermoset or thermoplastic resin;
b) optionally one or more tie layers,
c) one or more thermoplastic cap layers, and
d) a thin, outermost chemical resistant layer.

2. The weatherable, chemical resistant pultruded substrate of claim 1, wherein the chemical resistant layer is less than 0.5 mm in thickness.

3. The weatherable, chemical resistant pultruded substrate of claim 1, wherein the chemical resistant layer is selected from the group consisting of a fluoropolymer-rich blend of at least one polyvinylidene fluoride homopolymer or copolymer and one or more (meth)acrylic polymers.

4. The weatherable, chemical resistant pultruded substrate of claim 2, wherein the chemical resistant layer comprises a polymer matrix blend of 51 to 95 weight percent of polyvinylidene fluoride (PVDF) and 5 to 49 weight percent of (meth)acrylic resin.

5. The weatherable, chemical resistant pultruded substrate of claim 4, wherein the polyvinylidene fluoride polymer comprises greater than 60 weight percent of vinylidene fluoride monomer units, and the (meth)acrylic polymers comprise high molecular weight polymers, having a molecular weight of 50,000 to 500,000 g/mol.

6. The weatherable, chemical resistant pultruded substrate of claim 1, wherein the chemical resistant layer is a radiation curable acrylic layer.

7. The weatherable, chemical resistant pultruded substrate of claim 1, wherein at least one tie layer is selected from the group consisting of 1) an extrudable thermoplastic tie layer that is coextrudable with at least one of the pultruded structure a) or thermoplastic cap layer c), and 2) a radiation curable coating.

8. The weatherable, chemical resistant pultruded substrate of claim 1, wherein the optional tie layer is selected from the group consisting of polyamides, copolyamides, block copolymers of polyamide and polyester; acrylic, stryrenic or butadiene-based block copolymers, functionalized olefins, functionalized acrylics, polylactic acid (PLA), acrylonitrile-butadiene-styrene (ABS) copolymer, and a radiation-curable adhesive.

9. The weatherable, chemical resistant pultruded substrate of claim 1, wherein the pultruded structure comprises a polymer matrix selected from the group consisting of alkyds, diallyl phthalates, epoxies, melamines, ureas, phenolics, polyesters, polyurethanes, polyesters, a thermoplastic acrylic resin.

10. The weatherable, chemical resistant pultruded substrate of claim 1, wherein the cap layer comprises a thermoplastic selected from the group consisting of acrylics, styrenics and thermoplastic polyurethane.

11. The weatherable, chemical resistant pultruded substrate of claim 1, wherein the chemical resistant layer contains from 5 to 50 weight percent of impact modifier based on the total matrix polymer.

12. The weatherable, chemical resistant pultruded substrate of claim 1, wherein the cap layer, and/or the chemical resistant layer comprises from 0.2 to 5 weight percent of one or more UV absorbers.

13. An article comprising the weatherable, chemical resistant pultruded structure of claim 1.

14. The article of claim 13, wherein the article is selected from the group consisting of window profiles, doors, door profiles, playground equipment, utility poles, and sea walls.

15. A process for forming the weatherable, chemical resistant pultruded structure of claim 1 comprising the steps of:
a) forming a fiber-reinforced structure using a pultrusion process,
b) optionally applying one or more tie layers to the pultruded structure,
c) adhering one or more cap layers to the pultruded structure,
d) adhering a chemical resistant layer to the pultruded structure.

16. The process of claim 15, wherein the optional tie layer(s), cap layers and chemical resistant layer are coextruded onto pultruded structure.

17. The process of claim 15, wherein the chemical resistant layer is applied to the cap stock by coextrusion, film lamination, extrusion-lamination, insert molding, multi-shot injection molding, or compression molding.

18. The process of claim 15, wherein the cap layer is coated with a radiation curable coating, followed by extruding the one or more cap layers, followed by radiation curing the coating using LED, e-beam, or gamma radiation.
